(19) United States
(12) Patent Application Publication
(10) Pub. No.: US 2006/0271762 A1
(43) Pub. Date: Nov. 30, 2006

(54) Microcontroller and addressing method

(75) Inventor: Torsten Kramer, Hamburg (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., 5621 BA Eindhoven (NL)

(21) Appl. No.: 10/560,572

(22) PCT Filed: Jun. 4, 2004
(86) PCT No.: PCT/IB04/50842

§ 371 Date: Apr. 6, 2006

(30) Foreign Application Priority Data
Jun. 17, 2003 (EP) 03101766.8

(51) Int. Cl. G06F 12/00

(52) U.S. Cl. 711/212; 711/156

(57) ABSTRACT

In order to provide a microcontroller and an addressing method which are distinguished by a lower storage requirement and a higher execution speed than previously known when addressing N-bit address spaces, the address length N of the N-bit address word being greater than the address length of a standard set of instruction or of equivalents of other sets of instructions of the microcontroller, it is provided that the microcontroller (10) has at least one status bit (12) by means of which a writing and/or reading of N-bit address words by at least one standard instruction of the microcontroller (10) can be forced, and the at least one status bit (12) of a microcontroller (10) is set and as a a result a writing and/or reading of N-bit address words by means of at least one standard instruction of the microcontroller (10) is forced.

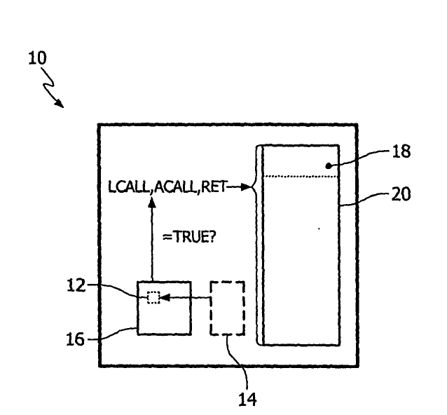

The invention relates to a microcontroller and to an addressing method having the features mentioned in the preambles of claims 1 and 6.

New generations of 8-bit microcontrollers use increasingly large address spaces of up to 16 Mbyte. For the addressing of such an extended address space, additional instructions such as ECALL and ERET have been introduced which address the entire address space by the use of 24-bit addresses and can write 24-bit addresses to the CPU stack and read them from the latter. The instructions LCALL, ACALL and RET of the 80C51 standard set of instructions or equivalents of other sets of instructions of 8-bit microcontrollers write and read only 16-bit addresses, even if the extended address area is used. They are thus practically unusable in the case of an extended address space, or can be used only under certain conditions. Use has to be made of the extended instructions ECALL and ERET or appropriate equivalents, which require considerably more code and also more time for execution.

It is therefore an object of the present invention to provide a microcontroller and an addressing method which are distinguished by a lower storage requirement and a higher execution speed than previously known when addressing address spaces with relatively large address lengths, in particular those of more than 16 bits.

This object is achieved according to the invention by a microcontroller having the features mentioned in claim 1 and an addressing method having the features mentioned in claim 6. The microcontroller according to the invention is distinguished in that the microcontroller has at least one status bit by means of which a writing and/or reading of N-bit address words by at least one standard instruction of the microcontroller can be forced, said standard instruction preferably being an LCALL, ACALL or RET instruction or the like, wherein the address length N of the N-bit address word is greater than the address length of a standard set of instructions or of equivalents of other sets of instructions of the microcontroller. The standard set of instructions is thus extended to the N-bit address space. In particular, the address length N of the N-bit address word is greater than 16. Particularly preferably, the address length N of the N-bit address word has the value 20, 24 or 32. This N-bit address space is thus not left only to additional dedicated instructions but rather the complete set of instructions can support extensions. This also avoids conflicts which may arise when for example an ECALL writes 3 bytes to the stack but the subroutine, under the assumption that there are only 16-bit addresses on the stack, returns only with RET. By virtue of the means according to the invention, a considerable reduction in the compiled code of about 5 to 10% and an increase in speed are achieved. A further advantage is that certain program optimizations are possible more easily, such as for example the ACALL optimization in which an attempt is made to replace LCALL/ECALL instructions by the significantly smaller ACALL instructions. Without the “Extended Call/Return Mode”, this optimization is ineffective.

In one preferred refinement of the invention it is provided that the at least one status bit can be set and/or deleted by means of at least one computer-readable storage medium. An increased flexibility of the microcontroller is thereby advantageously achieved.

Furthermore, in one preferred refinement of the invention it is provided that the at least one status bit is part of at least one Special Function Register (SFR), since the entire SFR can be written to and read from by means of the standard instructions of the microcontroller.

Moreover, in one preferred refinement of the invention it is provided that the at least one status bit is implemented in the hardware of the microcontroller, since in this way an increased efficiency is achieved.

The addressing method according to the invention is distinguished in that at least one status bit of a microcontroller is set and as a result a writing and/or reading of N-bit address words by means of at least one standard instruction of the microcontroller is forced, said standard instruction preferably being an LCALL, ACALL or RET instruction or the like. The standard set of instructions is thus extended to the N-bit address space. The latter is thus not left only to additional dedicated instructions but rather the complete set of instructions can support extensions. This also avoids conflicts which may arise when for example an ECALL writes 3 bytes to the stack but the subroutine, under the assumption that there are only 16-bit addresses on the stack, returns only with RET. By virtue of the means according to the invention, a considerable reduction in the compiled code of about 5 to 10% and an increase in speed are achieved. A further advantage is that certain program optimizations are possible more easily, such as for example the ACALL optimization in which an attempt is made to replace LCALL/ECALL instructions by the significantly smaller ACALL instructions. Without the “Extended Call/Return Mode”, this optimization is ineffective.

Within the context of the method according to the invention it is preferably provided that the at least one status bit is set and/or deleted by means of at least one computer-readable storage medium. An increased flexibility of the microcontroller is thereby advantageously achieved.

Furthermore, within the context of the method according to the invention it is preferably provided that the at least one status bit is part of at least one Special Function Register (SFR), since the entire SFR can be written to and read from by means of the standard instructions of the microcontroller.

Finally, within the context of the method according to the invention it is preferably provided that the at least one status bit is implemented in the hardware of the microcontroller, since in this way an increased efficiency is achieved.

Further preferred refinements of the invention emerge from the other features mentioned in the dependent claims.

The invention will be further described with reference to an example of embodiment shown in the drawing to which, however, the invention is not restricted.

The single FIGURE shows a microcontroller.

The FIGURE shows a schematic diagram of a microcontroller 10 according to the invention. Implemented within a Special Function Register 16 is a status bit 12 which can be set and deleted by means of a computer-readable storage medium 14. By the setting of the status bit 12, a writing or reading of N-bit address words having an address length of in this case e.g. N=24 to or from the stack by means of the standard instructions LCALL, ACALL and RET is forced, as a result of which the entire 24-bit address space 20 can be addressed. If the status bit 12 is not set, only the 16-bit address space 18 can be addressed by means of the standard instructions. By virtue of the means according to the invention, a reduced storage requirement and a higher execution speed of the compiled code of the microcontroller 10 compared to the prior art are achieved.

### LIST OF REFERENCES:

10 microcontroller
12 status bit
14 computer-readable storage medium
16 Special Function Register
18 16-bit address space
20 24-bit address space
N address length of the N-bit address word

1. A microcontroller, wherein the microcontroller has at least one status bit by means of which a writing and/or reading of N-bit address words by at least one standard instruction of the microcontroller can be forced, wherein the address length N of the N-bit address word is greater than the address length of a standard set of instructions or of equivalents of other sets of instructions of the microcontroller.

2. A microcontroller as claimed in claim 1, characterized in that the address length N of the N-bit address word is greater than 16.

3. A microcontroller as claimed in claim 2, characterized in that the address length N of the N-bit address word has the value 20, 24 or 32.

4. A microcontroller as claimed in claim 1, characterized in that the at least one standard instruction is an LCALL, ACALL or RET instruction or the like.

5. A microcontroller as claimed in claim 1, characterized in that the at least one status bit can be set and/or deleted by means of at least one computer-readable storage medium.

6. A microcontroller as claimed in claim 1, characterized in that the at least one status bit is part of at least one Special Function Register.

7. A microcontroller as claimed in claim 1, characterized in that the at least one status bit is implemented in the hardware of the microcontroller.

8. A microcontroller as claimed in claim 1, characterized by a design for use in a smartcard.

9. An addressing method, characterized in that at least one status bit of a microcontroller is set and as a result a writing and/or reading of N-bit address words by means of at least one standard instruction of the microcontroller is forced.

10. A method as claimed in claim 9, characterized in that the at least one standard instruction is an LCALL, ACALL or RET instruction or the like.

11. A method as claimed in claim 9, characterized in that the at least one status bit is set and/or deleted by means of at least one computer-readable storage medium.

12. A method as claimed in claim 9, characterized in that the at least one status bit is part of at least one Special Function Register.

13. A method as claimed in any of claims 9 to 12, characterized in that the at least one status bit is implemented in the hardware of the microcontroller.
